(19) United States
(12) Patent Application Publication
(10) Pub. No.: US 2002/0079158 A1
(43) Pub. Date: Jun. 27, 2002

(54) Acoustic liner and a fluid pressurizing device and method utilizing same

(76) Inventor: Zheji Liu, Olean, NY (US)

Correspondence Address: WARREN B. KICE, Haynes and Boone, L.L.P., Suite 3100, 901 Main Street, Dallas, TX, 75202-9918, US

(21) Appl. No.: 09/745,862

(22) Filed: Dec. 21, 2000

(51) Int. Cl. B64F 1/26; G10K 11/00; E04H 17/00

(52) U.S. Cl. 181/210; 181/211

(57) ABSTRACT

This invention relates to an acoustic liner for attenuating noise and consisting of a plurality of cells formed in a plate in a manner to form an array of resonators, and a fluid processing device and method incorporating same.

This invention relates to an acoustic liner and a fluid pressurizing device and method utilizing same.

Fluid pressurizing devices, such as centrifugal compressors, are widely used in different industries for a variety of applications involving the compression, or pressurization, of a gas. However, a typical compressor produces a relatively high noise level which is an obvious nuisance to the people in the vicinity of the device. This noise can also cause vibrations and structural failures.

For example, the dominant noise source in a centrifugal compressor is typically generated at the locations of the impeller exit and the diffuser inlet, due to the high velocity of the fluid passing through these regions. The noise level becomes higher when discharge vanes are installed in the diffuser to improve pressure recovery, due to the aerodynamic interaction between the impeller and the diffuser vanes.

Various external noise control measures such as enclosures and wrappings have been used to reduce the relative high noise levels generated by compressors, and similar devices. These external noise reduction techniques can be relatively expensive especially when they are often offered as an add-on product after the device is manufactured.

### SUMMARY

Accordingly an acoustic liner is provided, as well as a fluid processing device and method incorporating same, according to which the liner attenuates noise and consists of a plurality of cells formed in a plate in a manner to form an array of resonators.

### BRIEF DESCRIPTION OF THE DRAWINGS

FIG. 1 is a cross-sectional view of a portion of a gas pressurizing device and an acoustic liner according to an embodiment of the present invention.

FIG. 2 is an enlarged cross-sectional view of the acoustic liner of FIG. 1.

FIG. 3 is an enlarged elevational view of a portion of the liner of FIGS. 1 and 2.

FIG. 4 is a view similar to that of FIG. 1, but depicting additional acoustic liners disposed at other locations in the fluid pressurizing device.

FIG. 5 is a view similar to that of FIG. 1, but depicting another acoustic liner disposed around the inlet duct of the fluid pressurizing device.

### DETAILED DESCRIPTION

FIG. 1 depicts a portion of a high pressure fluid pressurizing device, such as a centrifugal compressor, including a casing 10 defining an impeller cavity 10a for receiving an impeller 12 which is mounted for rotation in the cavity. The impeller has openings, or flow passages, formed therethrough, one of which is shown by the reference numeral 12a. A channel 14 is provided in the casing 10 radially outwardly from the chamber 10a and the impeller 12, and receives the high pressure fluid from the impeller before it is passed to a volute, or collector, 16 for discharge from the device. Since this structure is conventional, it will not be shown or described in any further detail.

A mounting bracket 20 is secured to an inner wall of the casing 10 defining the diffuser area 14 and includes a base 22 disposed adjacent the outer end portion of the impeller and a plate 24 extending from the base and along the latter wall of the casing.

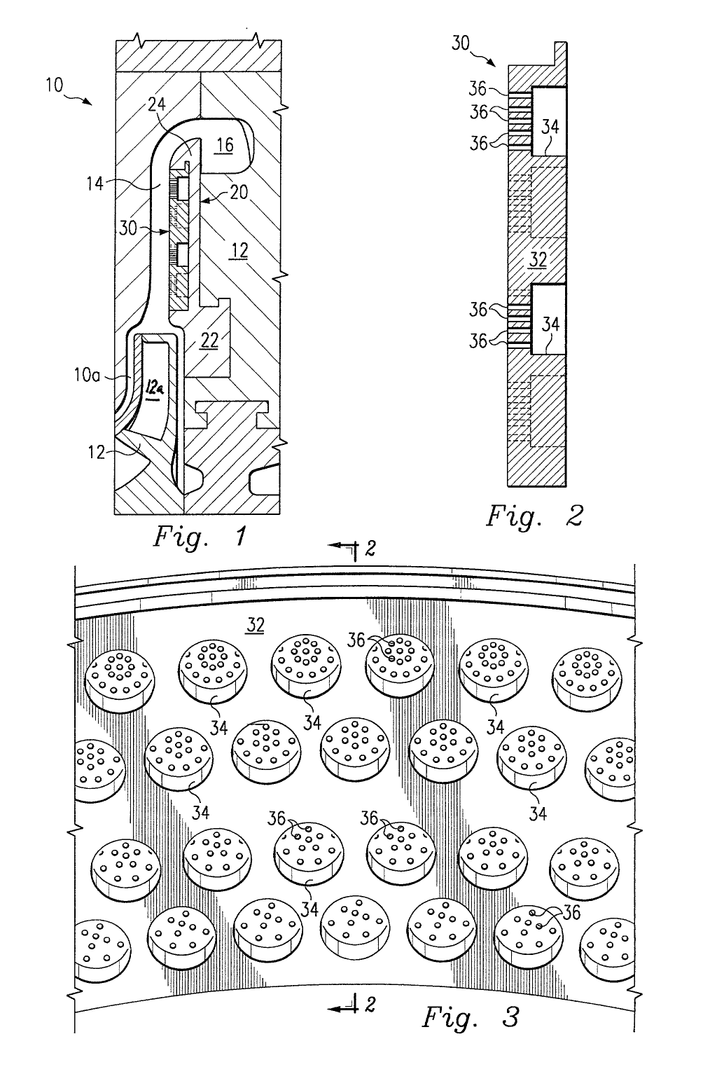

A one-piece, unitary, annular acoustic liner 30 is mounted to the bracket 20 with its upper section being shown in detail in FIGS. 2 and 3. The liner 30 is formed of an annular, relatively thick, unitary shell, or plate 32 which is secured to the plate 24 of the bracket 20 in any known manner. The plate 32 is preferably made of steel, and is attached to the bracket plate 24 by a plurality of equally-spaced bolts, or the like. The liner 30 is annular in shape and extends around the impeller 12 for 360 degrees.

A series of relatively large cells, or openings, 34 are formed through one surface of the plate 32 and extend through a majority of the thickness of the plate but not through its entire thickness. A series of relatively small cells 36 extend from the bottom of each cell 34 to the opposite surface of the plate 32. Each cell 34 is shown having a disc-like cross section and each cell 36 is in the shown in the form of a bore for the purpose of example, it being understood that the shapes of the cells 34 and 36 can vary within the scope of the invention.

According to one embodiment of the present invention, each cell 34 is formed by drilling a relative large-diameter counterbore through one surface of the plate 32, which counterbore extends through a majority of the thickness of the plate but not though the complete thickness of the plate. Each cell 36 is formed by drilling a bore, or passage, through the opposite surface of the plate 32 to the bottom of a corresponding cell 34 and thus connects the cell 34 to the diffuser area 14.

As shown in FIG. 3, the cells 34 are formed in a plurality of annular extending rows along the entire annular area of the plate 32, with the cells 34 of a particular row being staggered, or offset, from the cells of its adjacent row(s). A plurality of cells 36 are associated with each cell 34 and the cells 36 can be randomly disposed relative to their corresponding cell 34, or, alternately, can be formed in any pattern of uniform distribution.

The liner 30 is installed on the inner wall of the plate 24 of the bracket 20 so that the open ends of all the cells 34 are capped by the underlying wall of the plate. Due to the firm contact between the plate 32 of the liner and the bracket plate 24, and due to the cells 36 connecting each cell 34 to the diffuser area, the cells work collectively as array of Helmholtz acoustic resonators. Thus, the sound waves generated in the casing 10 by the high-rotation of the impeller 12, and by its associated components, are attenuated as they pass by the liner 30.

Moreover, the dominant noise component commonly occurring at the blade passing frequency, or other high frequency can be effectively lowered by tuning the liner 30 so that its maximum sound attenuation occurs around the latter frequency. This can be achieved by varying the volume of the cells 34, and/or the cross-section area, the number, and/or the length of the cells 36 to tune the liner. Thus, a maximum amount of attenuation of the acoustic energy generated by the rotating impeller 12 and its associated components can be achieved.

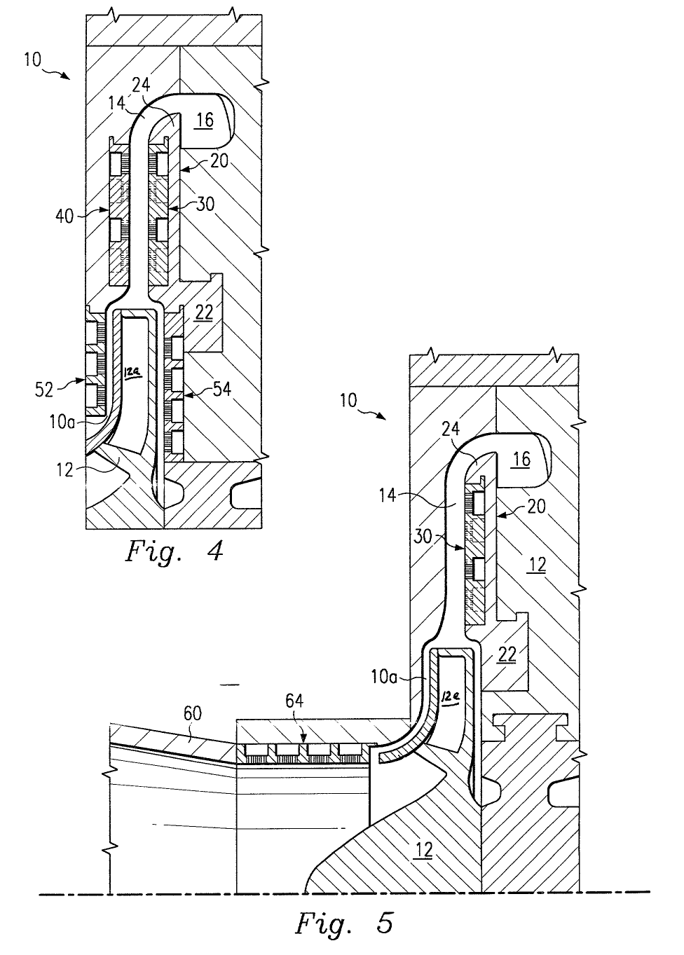

According to the embodiment of FIG. 4, an additional one-piece, unitary, annular liner 40 is provided on the internal wall of the casing 10 opposite the bracket plate 24 and defining, with the bracket plate, the diffuser channel 14. To this end, the latter wall is cut out as shown to accommodate the liner 40, which is identical to the liner 30 and therefore will not be described in detail. The liner 40 functions in an identical manner as the liner 30 as discussed above, and thus also contributes to a significant reduction of the noise generated by the impeller 12 and its associated components.

FIG. 4 also depicts two additional one-piece, unitary, annular liners 52 and 54 located at other preferred locations in the casing 10, i.e., to the front and the rear of the impeller 12. To this end, the corresponding portions of the internal walls of the casing 10 that houses the impeller 12 are cut out as shown to accommodate the liners 52 and 54. The liners 52 and 54 have a smaller outer diameter than the liners 30 and 40 and otherwise are identical to the liners 30 and 40. The liners 52 and 54 thus function in an identical manner as the liner 30 as discussed above, and thus contribute to a significant reduction of the noise generated in the casing 10.

The above-described preferred locations of the liners 30, 40, 52, and 54 enjoy the advantage of optimum noise reduction, since the liners are relatively close to the source of the noise, and therefore reduce the possibility that the noise will by-pass the liners and pass through a different path.

Still another preferred location for a liner is shown in FIG. 5 which depicts an inlet conduit 60 that introduces gas to the inlet of the impeller 12. The upper portion of the conduit 60 is shown extending above the centerline C/L of the conduit and the casing 10, as viewed in FIG. 5.

A one-piece, unitary, liner 64 is flush-mounted on the inner wall of the conduit 60 with the radial outer portion being shown. The liner 64 is in the form of a curved shell, preferably cylindrical in shape, is disposed in a cut-out recess of the inner surface of the conduit 60, and is attached in the recess in any known manner. Since the liner 64 is otherwise identical to the liners 30, 40, 52, and 54, it will not be described in further detail. The liner 64 also functions in an identical manner as the liner 30 as discussed above, and contributes to a significant attenuation of the noise in the casing 10.

It is understood that the liners 40, 52, 54 and 64 can be tuned to the impeller blade passing frequency to increase the noise reduction as discussed above in connection with the liner 30.

There are several advantages associated with the foregoing. For example, the liners 30, 40, 52, 54, and 64 are located to attenuate a maximum amount of noise near its source. Also, due to their one-piece, unitary construction, the liners 30, 40, 52, 54, and 64 have fewer parts and are mechanically stronger when compared to the composite designs discussed above. Also, given the fact that the frequency of the dominant noise component varies with the compressor speed, the number of the smaller cells 36 per each larger cell 34 can be varied spatially across the liners 30, 40, 52, 54, and 64 so that the entire liner is effective to attenuate noise in a broader frequency band. Consequently, the liners 30, 40, 52, 54, and 64 can efficiently and effectively attenuate noise, not just in constant speed machines, but also in variable speed compressors, or other fluid pressurizing devices. The liners 30, 40, 52, 54, and 64 also provide a very rigid inner wall to the internal flow. Further, relative to the three-piece sandwich structure used in the traditional configuration of conventional Helmholtz array acoustic liners, as discussed above, the liners according to the above embodiments of the present invention have less or no deformation when subject to mechanical and thermal loading. Therefore, the liners 30, 40, 52, 54, and 64 have no adverse effect on the aerodynamic performance of a centrifugal compressor, even when they are installed in the narrow passages such as the diffusor channels, or the like, of a centrifugal compressor.

### VARIATIONS

The specific arrangement and number of liners 30, 40, 52, 54, and 64 utilized are not limited to the number shown in FIGS. 1, 4 and 5. Thus, one or both of the liners 30 and 40 could be used in the diffuser channel 14, one or both of the liners 52 and 53 could be used around the impeller 12, and/or the liner 64 could be used around the inlet conduit 60, depending on the particular application.

The specific technique of forming the cells 34 and 36 can vary from that discussed above. For example, a one-piece liner can be formed in which the cells 34 and 36 are molded in the plate 32.

The relative dimensions and shapes of the cells 34 and/or 36 can vary within the scope of the invention,

The number and the pattern of the cells 34 and 36 in the plate 32 can vary.

The liners 30, 40, 52, 54, and 64 are not limited to use with a centrifugal compressor, but are equally applicable to other relatively high pressure gas pressurizing devices.

Each liner 30, 40, 52, 54 can extend for 360 degrees around the axis of the impeller 12, and the liner 64 can extend for 360 degrees around the axis of the conduit 60; or each liner can be formed into segments which extend an angular distance less than 360 degrees. For example, each liner 30, 40, 52, 54 and 64 could be formed by two or four segments each of which extends for 180 degrees or 90 degrees, respectively, with each segment having the unitary, one piece cross-section as described.

The spatial references used above, such as “bottom”, “inner”, “outer”, etc, are for the purpose of illustration only and do not limit the specific orientation or location of the structure

Since other modifications, changes, and substitutions are intended in the foregoing disclosure, it is appropriate that the appended claims be construed broadly and in a manner consistent with the scope of the invention.

What is claimed is:

1. A one-piece, unitary, acoustic liner comprising a unitary plate, and a plurality of cells formed in the plate in a manner to form an array of resonators to attenuate acoustic energy.

2. The liner of claim 1 wherein the resonators are Helmholtz resonators.

3. The liner of claim 1 wherein the cells are in the form of a first series of openings extending from one surface of the plate, and a second series of openings extending from the opposite surface of the plate

4. The liner of claim 3 where a plurality of openings of the second series of openings extend to one of each of the first series of openings.

5. The liner of claim 3 wherein each opening of the first series of openings is larger than each opening of the second series of openings.

6. The liner of claim 3 wherein the first and second series of openings are uniformly dispersed in the plate.

7. The liner of claim 3 wherein the number and size of the openings are constructed and arranged to tune the liner to attenuate the dominant noise component of the acoustic energy.

8. A fluid pressurizing device comprising a casing defining an inlet, and an outlet; an impeller mounted in the chamber and having a plurality of flow passages extending therethrough, the impeller adapted to rotate to flow fluid from the inlet, through the passages, and to the outlet for discharge from the casing; and at least one-piece, unitary, acoustic liner disposed in the chamber, the liner comprising a unitary plate, and a plurality of cells formed in the plate in a manner to form an array of resonators to attenuate acoustic energy generated by the device.

9. The liner of claim 8 wherein the resonators are Helmholtz resonators.

10. The liner of claim 8 wherein the cells are in the form of a first series of openings extending from one surface of the plate, and a second series of openings extending from the opposite surface of the plate

11. The liner of claim 10 where a plurality of openings of the second series of openings extend to one of each of the first series of openings.

12. The liner of claim 10 wherein each opening of the first series of openings is larger than each opening of the second series of openings.

13. The liner of claim 10 wherein the first and second series of openings are uniformly dispersed in the plate.

14. The liner of claim 10 wherein the number and size of the openings are constructed and arranged to tune the liner to attenuate the dominant noise component of the acoustic energy.

15. The device of claim 8 wherein the liner is attached to a wall defining a portion of the chamber.

16. The device of claim 8 further comprising at least one additional liner attached to a wall defining a portion of the chamber and extending opposite the first-mentioned wall, each additional liner comprising a unitary plate, and a plurality of cells formed in the plate in a manner to form an array of resonators to attenuate additional acoustic energy generated by the device.

17. The device of claim 8 wherein the casing further comprises a diffuser area in fluid flow communication with the impeller passages and the outlet, and further comprising at least one additional liner attached to a wall defining a portion of the diffuser area, each additional liner comprising a unitary plate, and a plurality of cells formed in the plate in a manner to form an array of resonators to attenuate additional acoustic energy generated in the diffuser area.

18. The device of claim 8 further comprising an inlet conduit connected to the inlet for supplying fluid to the inlet, and further comprising at least one additional liner attached to the conduit, each additional liner comprising a unitary curved shell, and a plurality of cells formed in the shell in a manner to form an array of resonators to attenuate additional acoustic energy generated by the device.

19. The device of claim 16, 17, or 18 wherein the latter resonators are Helmholtz resonators.

20. A fluid pressurizing device comprising a casing defining an inlet and an outlet; an impeller mounted in the chamber and having a plurality of flow passages extending therethrough; a diffuser area in fluid flow communication with the impeller passages and the outlet; the impeller adapted to rotate to flow fluid from the inlet, through the impeller passages and the diffuser area, and to the outlet for discharge from the casing; and a one-piece, unitary, acoustic liner disposed in the diffuser area, the liner comprising a unitary plate, and a plurality of cells formed in the plate in a manner to form an array of resonators to attenuate acoustic energy generated in the diffuser area.

21. The device of claim 20 wherein the resonators are Helmholtz resonators.

22. The device of claim 20 wherein the cells are in the form of a first series of openings extending from one surface of the plate, and a second series of openings extending from the opposite surface of the plate

23. The device of claim 22 where a plurality of openings of the second series of openings extend to one of each of the first series of openings.

24. The device of claim 22 wherein each opening of the first series of openings is larger than each opening of the second series of openings.

25. The device of claim 22 wherein the first and second series of openings are uniformly dispersed in the plate.

26. The device of claim 22 wherein the number and size of the openings are constructed and arranged to tune the liner to attenuate the dominant noise component of the acoustic energy.

27. The device of claim 20 wherein the liner is attached to a wall defining a portion of the diffuser area.

28. The device of claim 27 further comprising at least one additional liner attached to a wall defining a portion of the diffuser area and extending opposite the first-mentioned wall, each additional liner comprising a unitary plate, and a plurality of cells formed in the plate in a manner to form an array of resonators to attenuate additional acoustic energy.

29. The device of claim 28 wherein the latter resonators are Helmholtz resonators.

30. A fluid pressurizing device comprising a casing defining an inlet and an outlet; an impeller mounted in the chamber and adapted to rotate to flow fluid from the inlet and to the outlet for discharge from the casing; a conduit connected to the inlet for supplying fluid to the inlet; and a one-piece, unitary, acoustic liner attached to the conduit, the liner comprising a curved shell, and a plurality of cells formed in the shell in a manner to form a an array of resonators to attenuate acoustic energy generated by the device.

31. The device of claim 30 wherein the resonators are Helmholtz resonators.

32. The device of claim 30 wherein the cells are in the form of a first series of openings extending from one surface of the plate, and a second series of openings extending from the opposite surface of the plate

33. The device of claim 32 where a plurality of openings of the second series of openings extend to one of each of the first series of openings.

34. The device of claim 32 wherein each opening of the first series of openings is larger than each opening of the second series of openings.

35. The device of claim 32 wherein the first and second series of openings are uniformly dispersed in the plate.

36. The device of claim 32 wherein the number and size of the openings are constructed and arranged to tune the liner to attenuate the dominant noise component of the acoustic energy.

37. The device of claim 30 wherein the liner is attached to the internal surface of the conduit.
